(19) United States
(12) Patent Application Publication
(10) Pub. No.: US 2022/0398480 A1
(43) Pub. Date: Dec. 15, 2022

(54) EQUILIBRIUM MODELS ACCELERATION VIA JACOBIANS STABILIZATION SYSTEMS AND METHODS

(71) Applicant: Robert Bosch GmbH, Stuttgart (DE)

(72) Inventors: Shaojie BAI, Pittsburgh, PA (US); Vladlen KOLTUN, Santa Clara, CA (US); J. Zico KOLTER, Pittsburgh, PA (US); Devin T. WILLMOTT, Pittsburgh, PA (US); João D. SEMEDO, Pittsburgh, PA (US)

(21) Appl. No.: 17/343,286

(22) Filed: Jun. 9, 2021

(51) Int. Cl. G06N 7/08; G06N 7/00

(52) U.S. Cl. CPC G06N 7/08; G06N 7/005

(57) ABSTRACT

Regularized training of a Deep Equilibrium Model (DEQ) is provided. A regularization term is computed using a predefined quantity of random samples and the Jacobian matrix of the DEQ, the regularization term penalizing the spectral radius of the Jacobian matrix. The regularization term is included in an original loss function of the DEQ to form a regularized loss function. A gradient of the regularized loss function is computed with respect to model parameters of the DEQ. The gradient is used to update the model parameters.

### TECHNICAL FIELD

The present disclosure relates to a regularization system and method for the training of Deep Equilibrium Models (DEQs). This may be done to decrease training time while increase training stability.

### BACKGROUND

In an implicit deep learning layer, instead of a layer being a simple function with an explicit expression that can be evaluated to receive the output, the layer provides some analytical condition that the output of the layer must satisfy. While implicit layer models offer computer memory savings compared to more traditional network architectures, they are generally slower during both training and inference.

### SUMMARY

In one or more illustrative examples, a method for regularized training of a Deep Equilibrium Model (DEQ) is provided. A regularization term is computed using a predefined quantity of random samples and the Jacobian matrix of the DEQ, the regularization term penalizing the spectral radius of the Jacobian matrix. The regularization term is included in an original loss function of the DEQ to form a regularized loss function. A gradient of the regularized loss function is computed with respect to model parameters of the DEQ. The gradient is used to update the model parameters.

In one or more illustrative examples, a system for regularized training of a Deep Equilibrium Model (DEQ) is provided. In the system one or more computing devices are programmed to compute a regularization term using a predefined quantity of random samples and the Jacobian matrix of the DEQ, the regularization term penalizing the spectral radius of the Jacobian matrix, include the regularization term in an original loss function of the DEQ to form a regularized loss function, compute a gradient of the regularized loss function with respect to model parameters of the DEQ, and use the gradient to update the model parameters.

In one or more illustrative examples, a non-transitory computer-readable medium comprising instructions for regularized training of a Deep Equilibrium Model (DEQ) that, when executed by one or more computing devices, cause the one or more computing device to perform operations including to compute a regularization term using a predefined quantity of random samples and the Jacobian matrix of the DEQ, the regularization term penalizing the spectral radius of the Jacobian matrix, the predefined quantity being defined for approximating a Frobenius norm of the Jacobian matrix; include the regularization term in an original loss function of the DEQ to form a regularized loss function to regularize the Jacobian matrix using the Frobenius norm, the regularization term being weighted in the regularized loss function according to a predefined coefficient, the coefficient being configured to control a relative importance of the regularization term in the regularized loss function; compute a gradient of the regularized loss function with respect to model parameters of the DEQ; and use the gradient to update the model parameters.

### BRIEF DESCRIPTION OF THE DRAWINGS

FIG. 1A illustrates an example of training iterations versus forward relative residual of final outputs of a DEQ;

FIG. 1B illustrates an example of DEQ convergence residual versus Jacobian normalization in the same settings as FIG. 1A;

FIG. 1C illustrates an example of perplexity of DEQs on a model as a function of time;

FIG. 2 illustrates an example of Pre- vs. Post-LN DEQ-Transformer Layers;

FIG. 3A illustrates an example of training iterations vs. forward residual for an example data set;

FIG. 3B illustrates an example of training iterations vs. backward residual for the example data set of FIG. 3A;

FIG. 4 illustrates an example of trajectories of iteratively applying ƒ_{θ};

FIG. 5 illustrates an example visualization of the effect of the Jacobian regularization with different weights Υ;

FIG. 6 illustrates a visual comparison of different models with respect to various metrics;

FIG. 7 illustrates an example process for regularized DEQ training by adding a component to the loss function that penalizes the magnitude of the spectral radius of the Jacobian matrix;

FIG. 8 illustrates an example use of a trained DEQ may be used for sequence prediction;

FIG. 9 illustrates an example of a control system configured to control a vehicle;

FIG. 10 illustrates an example of a control system configured to control a monitoring system; and

FIG. 11 illustrates an example system for performing the regularized DEQ training of FIG. 7 for use, for example, as described in FIGS. 8-10.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A deep neural network may be defined with hidden layers z and activations ƒ such that z^{[i+1]}=ƒ(z^{[i]}, θᵢ, c(x)) for i=0, 1, 2, . . . , L with weights θᵢ and previous layer inputs c(x) are both tied across layers, i.e., θᵢ=θ∀i. Some of these activations ƒ may exhibit an attractor property, i.e., there exists a fixed point z* such that z*=ƒ(z*, θ, c(x)) and

$${lim}_{L \to ∞} {( f ∘ … ∘ f )}_{\underbrace{L - times}} ( {z}^{[ 0 ]} , θ , c ( x ) ) = {z}^{*} ,$$

i.e., the repeated application of ƒ for an initial activation z^{[0]} converges to a fixed point z*. If this is the case, the iterated function application may be equivalently replaced by a numerical method to find the fixed-point directly. This shifts the problem from computing the forward and backward passes for multiple layers to computing and optimizing the fixed point directly via numerical methods. This approach may be referred to as a Deep Equilibrium Model (DEQ).

While DEQs have been shown perform comparably to traditional network architectures (i.e., explicit networks) on a variety of domains, they may suffer from one or more of the following drawbacks: (1) growing instability during training; (2) inefficiency compared to explicit networks; (3) brittleness to architectural choices; and (4) dependency on the choice of solver. One way to address one or more of these shortcomings is to regularize DEQ training. Previous approaches to regularization include weight normalization, recurrent dropout and group normalization. While they have led to incremental improvements, these methods are borrowed from explicit network training, where they are known to work well, and do not leverage the structure of implicit layer models such as DEQs.

In this disclosure, a regularization scheme for DEQ models is described that explicitly regularizes the Jacobian of the fixed point update equations to encourage simpler and stabler equilibrium networks being learned. More specifically, during training, the backwards pass in a DEQ can be done by differentiating directly through the fixed point z* using:

$$\frac{\partial ℓ}{\partial ( . )} = \frac{\partial ℓ}{\partial {z}^{*}} {( I - {J}_{f θ} ( {z}^{*} ) )}^{- 1} \frac{\partial {f}_{θ} ( {z}^{*} ; x )}{\partial ( . )}$$

where J_{ƒ}_{_{θ}}(z*)∈ [symbol] ^{d×d} is the Jacobian matrix of the layer function ƒ_{θ} at the fixed point z*. However, because the scale of J_{ƒ}_{_{θ}} can be prohibitively large and the inverse is costly to compute, the

$${u}^{T} = {u}^{T} {J}_{f θ} ( {z}^{*} ) + \frac{\partial ℓ}{\partial {z}^{*}}$$

term is usually computed by solving the following linear fixed-point system that depends on the final Jacobian:

$$\frac{\partial ℓ}{\partial {z}^{*}} {( I - {J}_{f θ} ( {z}^{*} ) )}^{- 1} = {u}^{T}$$

The stability of this fixed point system is directly affected by the spectral radius ρ of the Jacobian J_{ƒ}_{_{θ}}(z*). In particular, if ρ<1, convergence is guaranteed. Directly imposing this condition, however, may be too restrictive for practical use. Thus, in this disclosure it is proposed to regularize training by instead adding a new component to the loss function that penalizes the magnitude of the spectral radius of the Jacobian matrix, leading to better conditioned fixed-point systems. Furthermore, since the exact computation of the spectral radius of the Jacobian matrix requires decomposition (e.g., via singular value decomposition (SVD)), the Jacobian may be regularized using its Frobenius norm, since:

ρ(J_{ƒ}_{_{θ}})≤≤\sqrt{tr(J_{ƒ}_{_{θ}}J_{ƒ}_{_{θ}}^{T})}=∥J_{ƒ}_{_{θ}}∥_{F}

where ∥.∥_{F} denotes the Frobenius norm. In one example, the Hutchinson estimator may be used to estimate the Frobenius norm, given by E_{ϵ∈N(0, I}_{_{d}}₎∥ϵ^{T}J_{ƒ}_{_{θ}}∥₂², which may be approximated by Monte-Carlo estimation.

This regularization may add only minimal computational cost, but significantly accelerates the fixed-point-solving convergence in both forward and backward passes, and scales well to high-dimensional, realistic domains (e.g., WikiText-103 language modeling and ImageNet classification). Using such an approach, an implicit-depth model that runs with approximately the same speed and level of performance as conventional deep networks can be performed (e.g., ResNet-101, Transformers), while still maintaining the O(1) memory benefit and architectural simplicity of DEQ models.

While prior DEQs adopted regularization methods directly borrowed from explicit deep networks, the disclosure introduces a simple and theoretically-motivated Jacobian regularization pursuant to DEQ models' implicitness. This Jacobian regularization relates to the contractivity of DEQ's forward non-linear system and backward linear system, and thus is able to effectively stabilize not only forward but also backward dynamics of DEQ networks. There are two immediate benefits of the resulting more stable dynamics. First, solving a DEQ requires far fewer iterations than before, which makes regularized DEQs significantly faster than their unregularized counterparts. Second, this class of model becomes much less brittle to architectural variants that would otherwise break the DEQ.

The proposed regularization may be validated by experiments on both toy-scale (synthetic) tasks and large-scale datasets across domains: word-level language modeling on WikiText-103 (Merity et al., 2017) and high-resolutional image classification on the full ImageNet dataset (Deng et al., 2009). Empirically, the disclosed regularized DEQs are generally 2× to 3× faster than prior DEQs, and can be accelerated to be as fast as explicit deep networks (e.g., ResNets, DenseNets, and Transformers). These implicit models may be accelerated to this level without sacrificing scalability, accuracy, or structural flexibility. With their O(1) memory footprint, this further establishes implicit models as a strong competitor to explicit deep architectures.

Regarding deep equilibrium models, given a layer/block ƒ_{θ} (which may contain a few shallow sublayers) and an input x, a deep equilibrium model aims to approximate an “infinite-level” layer stacking of the form z[ⁱ⁺¹]=ƒ_{θ}(z^{[i]}; x) (where i=1; . . . ; L, with L→∞) by directly solving for its fixed-point representation:

z*=ƒ_{θ}(z*;x)

One of the appealing properties of this fixed-point formulation is that one can implicitly differentiate through the equilibrium feature, without dependency on any intermediate activations in the forward pass. Formally, given a loss l, one can directly compute the gradient using the final output:

$$\frac{\partial ℓ}{\partial ( . )} = \frac{\partial ℓ}{\partial {z}^{*}} {( I - {J}_{{f}_{θ}} ( {z}^{*} ) )}^{- 1} \frac{\partial {f}_{θ} ( {z}^{*} ; x )}{\partial ( . )}$$

where J_{ƒ}_{_{θ}}(z*) is the Jacobian matrix at equilibrium z*. To solve for the equilibrium, Broyden's method may be used to find the root of ƒ_{θ}(z*; x)−z*=0. Later works have applied other algorithms, such as Peaceman-Rachford splitting and Anderson acceleration.

Compared to Neural ODEs, deep equilibrium networks have been demonstrated to be able to scale well to large and high-dimensional tasks, such as language modeling, ImageNet classification, semantic segmentation, etc., and are thus more applicable to domains where deep learning has been traditionally successful. However, unlike ODE flows, DEQ networks do not have a unique trajectory, and are not guaranteed to converge.

In this disclosure, it is demonstrated how a DEQ model can be regularized by bounding the spectral radius of its Jacobian. In contrast to other works, the disclosed approach shows directly via the lens of fixed-point convergence how the Jacobian is closely tied to the stability of the forward and backward passes of DEQs. It can be demonstrated that this regularization significantly accelerates DEQs to be as fast as explicit architectures (e.g., only ≤5 NFEs on CIFAR-10 may be required), on tasks across different scales and with comparable accuracy.

Although a DEQ network has no “depth”, a relevant measure of computational efficiency is the number of function evaluations (NFEs) of the layer ƒ_{θ}(z; x) used by the iterative root solver (e.g., Broyden's method (Broyden, 1965)).

However, one common phenomenon to DEQs is that the fixed points are increasingly harder to solve for over the course of model training. In other words, as a DEQ's performance gradually improves during training, the NFE required to converge to the same threshold ε (e.g., 10⁻³) rapidly grows. This observation has been made on different instantiations of equilibrium networks, and regardless of whether the model is provably convergent or not. Intuitively, such tendency to approach “critical stability” implicitly characterizes an inclination of the model to learn “deeper” networks; so it is unsurprising that unregularized training will keep driving it in this direction. But as a result, the dynamical system only becomes more and more brittle. The existing way of “addressing” this is to circumvent it by setting a maximum NFE limit besides the ε-threshold; i.e., the solver stops either when 1) the residual is smaller than E, or 2) it has run for a max number of steps T. This could be risky because as the convergence gets more unstable/critical, such a hard stop for the solver cannot guarantee that we are close enough to the fixed point. In the backward pass, for instance, we may consequently be training DEQs with very noisy gradients. A similar issue exists for Neural ODEs, though these cannot easily be hard-stopped like DEQs due to the need to accurately trace the flow to the endpoint.

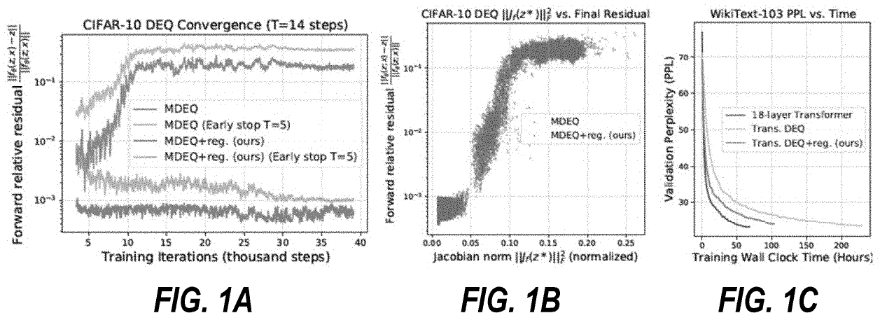

FIG. 1A illustrates an example of training iterations versus forward relative residual of final outputs of a DEQ. FIG. 1B illustrates an example of DEQ convergence residual versus Jacobian normalization in the same settings as FIG. 1A. FIG. 1C illustrates an example of perplexity of DEQs on a model as a function of time. In the illustrated example, FIG. 1A shows an example CIFAR-10 classification. As indicated, it can be identified that both forward and backward estimates of the fixed points become increasingly worse with the training steps. Such growing instability is also reflected empirically in the growth of Jacobian norm at equilibrium;

$$i . e . , ‖ \frac{\partial {f}_{θ} ( {z}^{*} ; x )}{\partial {z}^{*}} ‖ .$$

Moreover, while these plots might suggest simple regularizations like weight decay, it can further be shown that weight decay often makes this stability issue worse for equilibrium networks, and even leads to divergence. A direct ramification of the increase in iterations required is the significant increase in both training and inference time for DEQ models.

One advantage of DEQs is that the forward trajectory need not strictly reach the equilibrium. Therefore, in a certain sense, performance can be traded for efficiency by stopping at a “good enough” estimate of the equilibrium. However, due to the growing instability problem, this could still be increasingly costly. This causes the existing DEQs to be significantly slower than their explicit network counterparts of comparable size and performance. E.g., a DEQ-Transformer (Bai et al., 2019) is about 2.9× slower than a deep Transformer-XL (Dai et al., 2019); a multiscale DEQ (Bai et al., 2020) is over 3.5× slower than ResNet-101 on ImageNet. Despite their memory efficiency, such slowdown is a roadblock to wider deployment of this class of models in practice. FIG. 1C illustrates this slowdown more specifically on the validation set of WikiText-103 language modeling (with comparable model sizes and the same number of training steps).

The desire to have a relatively stable DEQ in order to train it via the implicit function theorem also calls for more careful attention in designing the layer ƒ_{θ}. For example, large-scale DEQs may utilize normalizations at the end of the layer to constrain the output range. The brittleness of DEQs may be demonstrated by ablative studies on the use of layer normalization (LN) or weight normalization (WN) in the DEQ-Transformer model on the large-scale WikiText-103 language modeling task.

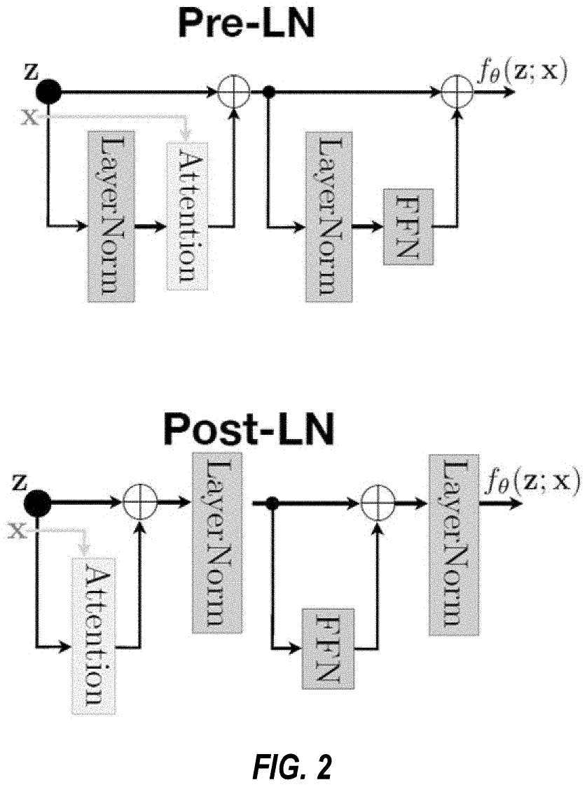

FIG. 2 illustrates an example of Pre- vs. Post-LN DEQ-Transformer Layers. Specifically, the use of the two most popular Transformer layer designs in the DEQ framework: pre-LN and post-LN, may be compared, which simply inserts the LN layers at different parts of the block.

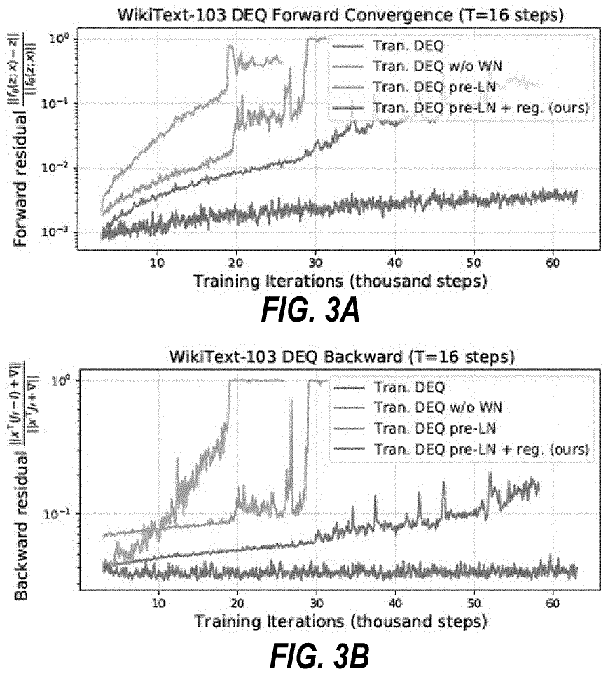

The result is shown in FIGS. 3A and 3B. FIG. 3A illustrates an example of training iterations vs. forward residual for an example data set. FIG. 3B illustrates an example of training iterations vs. backward residual for the example data set of FIG. 3A. Without layer normalization at the end, the DEQ quickly diverges after 25K training iterations (reflected in both forward and backward divergences). Similarly, without weight normalization, the model becomes unstable more quickly, with fixed-point solver collapse at around 18K iterations. The original DEQ-Transformer although not diverged, still suffers from increased instability. These plots are strong indicators that while equilibrium networks work on large scales, they are also relatively inflexible, brittle, and reliant on meticulous architectural designs.

Although DEQ models enjoy constant memory consumption during training time and can use any black-box fixed point solvers in the forward and backward passes, a commonly neglected cost is that introduced by the choice of solver. For example, in Broyden's method, the inverse Jacobian J⁻¹ is approximated by low-rank updates of the form J⁻¹≈−I+Σᵢ₌₁ⁿ u^{[n]}v^{[n]}^{^{T}}=−I+UV^{T}. As another example, Anderson mixing stores and uses the past m iterations (z^{[n-1]}, . . . , z^{[n-m]}). In most such cases, even storing these updates or past steps can be expensive. Moreover, since one may depend on the same DEQ solvers also at inference time, this same memory cost may be spent even when the trained model is served—which conventional deep networks can avoid. This cost depends strongly on the solver; for example, the simplest iterative “solver” z^{[i+1]}=ƒ_{θ}(z^{[i]}; x) would not have any memory cost, but suffers from bad convergence. This issue further highlights the value of faster convergence (which entails smaller storage), as well as future directions for potentially developing hyper-solvers.

It may be hypothesized that one of the fundamental factors contributing to the aforementioned issues is that DEQ models' conditioning is not properly regularized during training. Such trend for DEQ models to go unstable is reflected in FIGS. 1A and 1B, where increasing training steps leads to monotonically growing residual difference and the Jacobian norm at the equilibrium. Yet, the Jacobian may be related to the stability of equilibrium networks' forward and backward passes, and this relationship may be harnessed to stabilize and accelerate DEQs.

The forward pass of a DEQ network aims to solve for the fixed-point representation z* of a layer ƒ_{θ}(.; x); i.e., z*=ƒ_{θ}(z*). Then in the backward pass, one can differentiate directly through the equilibrium z* by

$$\frac{\partial ℓ}{\partial ( \cdot )} = {\frac{\partial ℓ}{\partial {z}^{*}} {( I - {J}_{f θ} ( {z}^{*} ) )}^{- 1}}_{\underbrace{{u}^{T}}} \frac{\partial {f}_{θ} ( {z}^{*} ; x )}{\partial ( \cdot )} . \qquad ( 1 )$$

However, because the scale of J_{ƒ}_{_{θ}} can be prohibitively large and the inverse is costly to compute, the u^{T} term in Eq. 1 may be computed by solving the following linear fixed-point system that depends on the final Jacobian:

$${u}^{T} = {u}^{T} {J}_{f θ} ( {z}^{*} ) + \frac{\partial ℓ}{\partial {z}^{*}} . \qquad ( 2 )$$

Consider the spectral radius of the Jacobian J_{ƒ}_{_{θ}}∈ [symbol] ^{d×d} at the equilibrium:

ρ(J_{ƒ}_{_{θ}}(z*))=σ(J_{ƒ}_{_{θ}}(z*)^{T})=max(|λ₁|, . . . ,|λ_{d}|),

where λᵢs are eigenvalues. In both the forward and backward passes, this spectral radius directly affects how stable the convergence to the fixed point z* could be in its neighborhood. For instance, in the extreme case where we have a contractive ρ(J_{ƒ}_{_{θ}})<1, by Lyapunov linearization theorem even the simplest iterative calls to ƒ_{θ}(z) (in forward, assuming a good initial estimate) or

$$g ( u ) = {u}^{T} {J}_{f θ} ( {z}^{*} ) + \frac{\partial ℓ}{\partial {z}^{*}}$$

(in backwards) could converge uniquely, even without advanced solvers. The linear system of Equation 2 enjoys global asymptotic stability. In practice, such a strong contractivity is not required on the dynamical system, as it might significantly limit the representational capacity of the model.

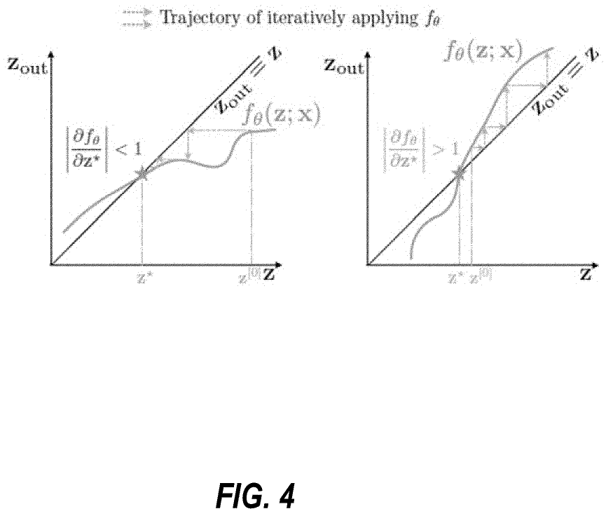

FIG. 4 illustrates an example of trajectories of iteratively applying ƒ_{θ}. As shown on the left, when the slope is less than 1, even the simplest iterative application of ƒ_{θ} converges. As shown on the right, a fixed point can exist even if ρ(J_{ƒ}_{_{θ}})>1 (where the slope is greater than 1 of the curve slope in 2D); and can be solved for them using the much stronger root solvers (e.g., Newton or quasi-Newton) than these simplest iterative stackings, which could oscillate or diverge.

These connections between J_{ƒ}_{_{θ}}(z*) (which characterizes the shape of the transformation ƒ_{θ} around z*) and the forward/backward pass dynamics of DEQs motivate one to append a soft and auxiliary Jacobian term ρ(J_{ƒ}_{_{θ}}(z*)) to the training objective in order to regularize the model's conditioning. One way of doing this is by spectral normalization, essentially constraining:

σ(J_{ƒ}_{_{θ}})=max_{∥ν∥≤1}∥J_{ƒ}_{_{θ}}v∥₂

However, explicitly writing out the very large Jacobian and then decomposing it (e.g., by SVD) can be computationally prohibitive. In the context of DEQs, even power iterations are too expensive due to the successive vector-Jacobian product computations needed.

Instead, the disclosed approach includes to regularize the Jacobian through its Frobenius norm since:

ρ(J_{ƒ}_{_{θ}})≤σ(J_{ƒ}_{_{θ}})≤\sqrt{tr(J_{ƒ}_{_{θ}},J_{ƒ}_{_{θ}}^{T})}=∥J_{ƒ}_{_{θ}}∥_{F}.

Importantly, ∥J_{ƒ}_{_{θ}}∥_{F} can be approximated via various unbiased estimators. For example, the classical Hutchinson estimator may be used J_{ƒ}_{_{θ}}∈ [symbol] ^{d×d},

tr(J_{ƒ}_{_{θ}},J_{ƒ}_{_{θ}}^{T})= [symbol] [∥ϵ^{T}J_{ƒ}_{_{θ}}∥₂²], (3)

which we can approximate by Monte-Carlo estimation (i.e., sampling M i.i.d. ϵᵢ∈N(0, I_{d})). Empirically, M=1 may works well enough for each sample in a batch. Since the backward iterations already involve computing multiple vector-Jacobian products u^{T}J_{ƒ}_{_{θ}} (see Eq. (2)), computing Equation 3 only adds a cost equivalent to that of M=1 backward step. The eventual training objective is thus:

$${ℒ}_{total} ( {z}^{*} ) = {ℒ}_{orig} ( {z}^{*} ) + γ \frac{{‖ {ϵ}^{T} {J}_{f θ} ( {z}^{*} ) ‖}_{2}^{2}}{d} , ϵ ∈ 𝒩 ( 0 , {I}_{d} ) \qquad ( 4 )$$

As shown in FIG. 1A, without regularization, a DEQ model that stops after a fixed number T of solver iterations exhibits increasingly poor convergence, accompanied by a growing ∥J_{ƒ}_{_{θ}}∥_{F} at these fixed points that empirically signals the growing instability. Therefore, by constraining the Jacobian's Frobenius norm, DEQs can be optimized for stabler and simpler dynamics whose fixed points are easier to solve for.

Although the loss objective Equation 4 only adds minimal computation cost, the need to back propagate through ∥ϵ^{T}J_{ƒ}_{_{θ}}∥₂² means more memory is spent during training to store the computation graph of this vector-Jacobian product. But at the same time, hidden memory cost due to the solver choice is smaller (e.g., via Broyden's method) as the number of iterations can be lowered. As a result, we notice a roughly 30% net growth in memory consumption is identified compared to the unregularized DEQs at training (and thus saving 50%-60% memory compared to explicit deep networks). The regularized DEQ still consumes O(1) memory relative to the “depth” of the model, as the backpropagation depends only on z*.

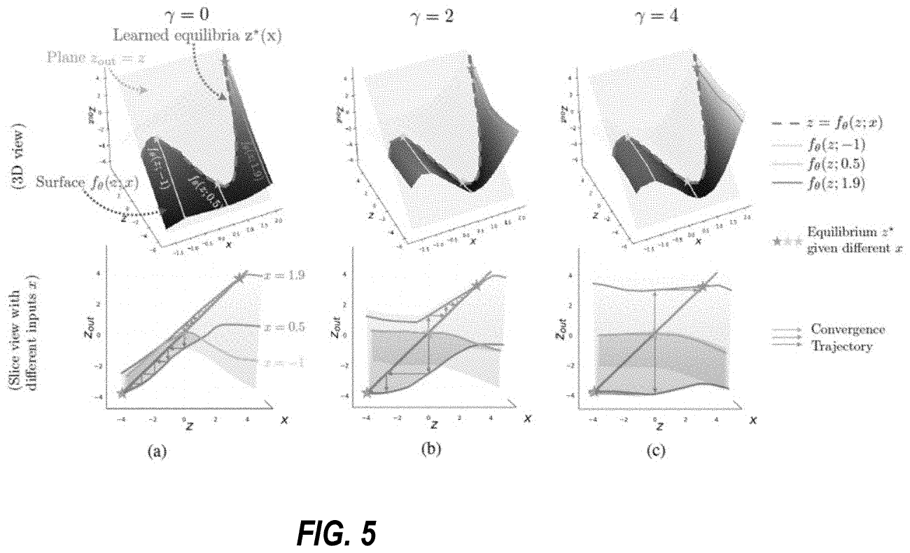

FIG. 5 illustrates an example visualization of the effect of the Jacobian regularization with different weights γ. In particular, each input x defines a slice (i.e., cross-section) of the 3D surface zₒᵤₜ=ƒ_{θ}(z; x); for example, layer ƒ_{θ}(z; x) when input x=−1. After training, all three settings successfully learned the (almost) identical equilibrium function z*(x) (highlighted by the dashed line) that perfectly fits the target function h(x); but note that surfaces of ƒ_{θ} with γ=2, 4 are “lifted up” significantly compared to the unregularized (γ=0) DEQ, which has a steep slope. This slope slows down the fixed-point convergence, as reflected by the zigzag patterns in lower portion of FIG. 5. In contrast, the convergence for γ>0 is much faster.

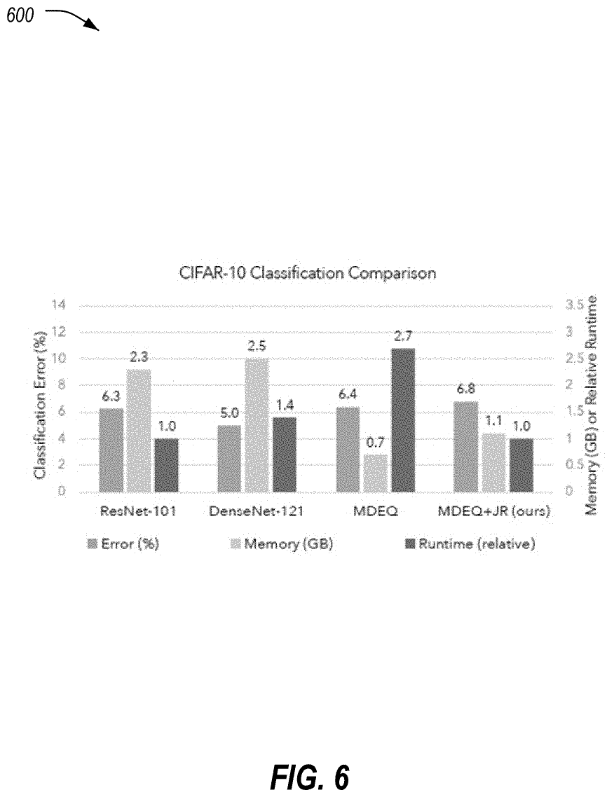

FIG. 6 illustrates a visual comparison of different models with respect to the metrics of performance, inference speed, and training memory. As shown, with the proposed regularization, DEQ models are competitive with popular networks in accuracy, memory, and runtime. Lower bars are better.

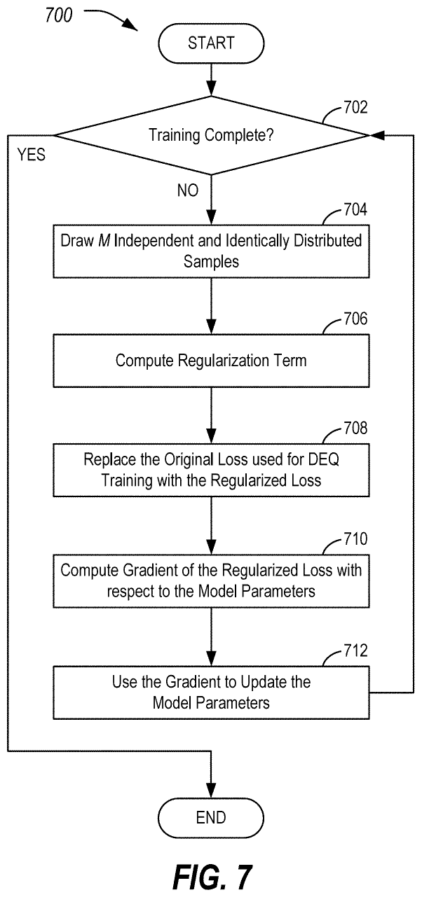

FIG. 7 illustrates an example process 700 for regularized DEQ training by adding a component to the loss function that penalizes the magnitude of the spectral radius of the Jacobian matrix. The process 700 may receive hyperparameters of:

γ, the coefficient which controls the relative importance of the regularization term; and

M, the number of samples used to approximate the Hutchinson Frobenius norm estimator.

The process 700 may also receive a Layer function ƒ_{θ} and original training loss [symbol] _{orig}(z*).

At operation 702, it is determined whether there are additional training steps or if training is complete. If there are additional training steps, the process 700 continues to operations 704 through 712 to perform the training.

At operation 704, the process 700 draw M independent and identically distributed (i.i.d.) samples ϵₘ^{T}∈N(0, I_{d}). The assumption or requirement that observations be i.i.d. may be a simplification. The quantity M may be input to the process 700 as noted above.

At operation 706, the process 700 computes the regularization term using a regularized loss function. The term may be computed using the M samples ϵₘ^{T} drawn at operation 704. The loss function may add a new component that penalizes the magnitude of the spectral radius of the Jacobian matrix. As noted herein, the regularization term may be defined via the regularized loss function:

$${ℒ}_{reg} ( {z}^{*} ) = \frac{1}{M} \cdot {\sum }_{m = 1}^{M} {‖ {ϵ}_{m}^{T} {J}_{{f}_{θ}} ( {z}^{*} ) ‖}_{2}^{2}$$

The Jacobian may be regularized using its Frobenius norm, since:

ρ(J_{ƒ}_{_{θ}})≤\sqrt{tr(J_{ƒ}_{_{θ}}J_{ƒ}_{_{θ}}^{T})}=∥J_{ƒ}_{_{θ}}∥_{F}

where ∥.∥_{F} denotes the Frobenius norm. In one example, the Hutchinson estimator may be used to estimate the Frobenius norm, given by E_{ϵ∈N(0, I}_{_{d}}₎∥ϵ^{T}J_{ƒ}_{_{θ}}∥₂², which may be approximated by Monte-Carlo estimation.

At operation 708, the process 700 replaces the original loss function used for the DEQ training with the regularized loss function as computed at operation 706. For instance, the original loss [symbol] _{orig}(z*) may be replaced by the regularized version including an additional weighted regularization term:

$${ℒ}_{total} ( {z}^{*} ) = {ℒ}_{orig} ( {z}^{*} ) + γ \frac{{ℒ}_{reg} ( {z}^{*} )}{d}$$

At operation 710, the process 700 computes the gradient of the regularized loss [symbol] ₜₒₜₐₗ with respect to the model parameters as the backwards pass. At operation 712, the process 700 uses the gradient to update the model parameters. After operation 712, the process 700 returns to operation 702.

Variations on the process 700 are possible. For instance, for operations 704 and 706 the Hutchinson estimator may be replaced by a different estimator of the Frobenius norm of the Jacobian matrix. As one possibility, an upper bound on the spectral radius of the Jacobian matrix can be used as well.

Thus, as compared to both unregularized training and alternative regularization strategies, this disclosed approach leads to stabilized training and faster training and inference. This approach accordingly leads to examples of implicit layer models that are on par with traditional network architectures both in terms of accuracy and inference time, while retaining the memory efficient advantages of implicit layer models.

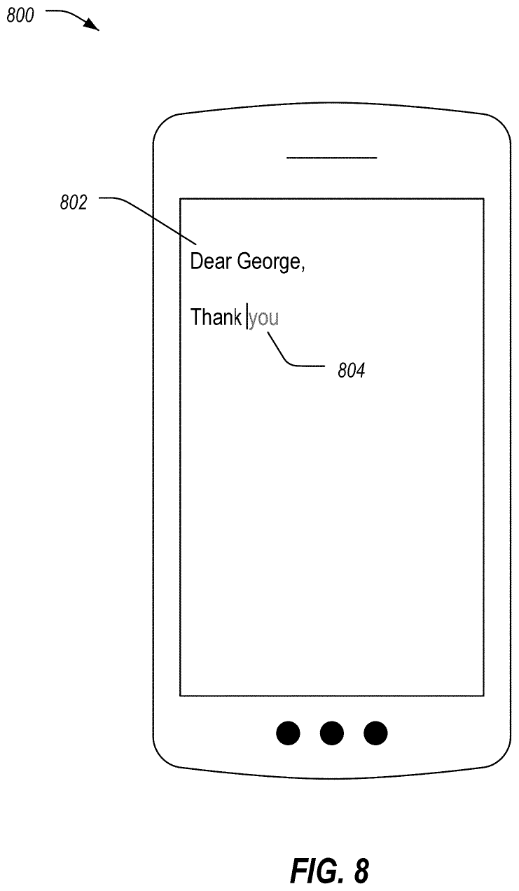

By using the disclosed techniques, DEQs may be better used for various tasks. In an example such a trained DEQ may be used for sequence prediction or other tasks that require good memory retention. For instance, the DEQs may be used in language modeling, e.g., to predict the next character or word in a document. An example 800 of such an approach is shown in FIG. 8, in which document text 802 is received from the user from one or more input devices, such as a keyboard or microphone. Moreover, using the DEQ trained for sequence prediction, predicted text 804 may further be offered to the user to aid in the composition of the document text 802 by the user. The predicted text 804 may be shown as a suggestion after the document text 802, as determined by the DEQ. In the illustrated example 800, predicted text 804 of “you” is offered for document text 802 following the word “thank.”

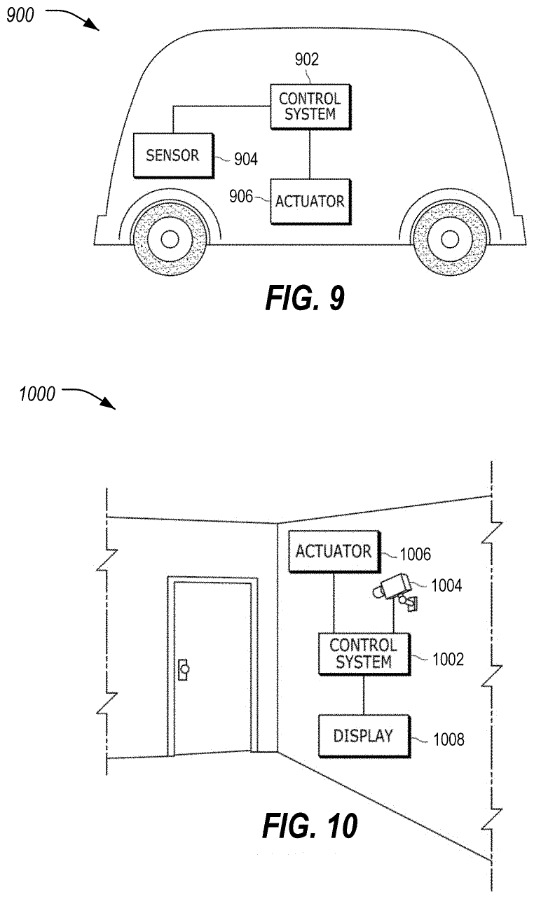

In another example, such a DEQ may be used for computer vision tasks, such as image classification or semantic segmentation. For instance, FIG. 9 illustrates an example 900 of a control system configured to control a vehicle. The vehicle may be an at least partially autonomous vehicle or an at least partially autonomous robot. The vehicle includes a sensor 904 and an actuator 906. The sensor 904 may include one or more wave energy based sensor (e.g., a Charge Coupled Device CCD, or video), radar, LiDAR, microphone array, ultrasonic, infrared, thermal imaging, acoustic imaging or other technologies (e.g., positioning sensors such as GPS). One or more of the one or more specific sensors may be integrated into the vehicle. Alternatively or in addition to one or more specific sensors identified above, the control module 902 may include a software module configured to, upon execution, determine a state of actuator 906.

In embodiments in which the vehicle is an at least a partially autonomous vehicle, actuator 906 may be embodied in a brake system, a propulsion system, an engine, a drivetrain, or a steering system of the vehicle. Actuator control commands may be determined such that actuator 906 is controlled such that the vehicle avoids collisions with detected objects. Detected objects may also be classified according to what the classifier deems them most likely to be, such as pedestrians or trees. The actuator control commands may be determined depending on the classification. For example, control system 902 may segment an image (e.g., optical, acoustic, thermal) or other input from sensor 904 into one or more background classes and one or more object classes (e.g. pedestrians, bicycles, vehicles, trees, traffic signs, traffic lights, road debris, or construction barrels/cones, etc.), and send control commands to actuator 906, in this case embodied in a brake system or propulsion system, to avoid collision with objects. In another example, control system 902 may segment an image into one or more background classes and one or more marker classes (e.g., lane markings, guard rails, edge of a roadway, vehicle tracks, etc.), and send control commands to actuator 906, here embodied in a steering system, to cause the vehicle to avoid crossing markers and remain in a lane. In a scenario where an adversarial attack may occur, the system described above may be further trained to better detect objects or identify a change in lighting conditions or an angle for a sensor or camera on the vehicle.

In other embodiments where vehicle 900 is an at least partially autonomous robot, vehicle 900 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 906 may be determined such that a propulsion unit, steering unit and/or brake unit of the mobile robot may be controlled such that the mobile robot may avoid collisions with identified objects.

In another embodiment, vehicle 900 is an at least partially autonomous robot in the form of a gardening robot. In such embodiment, vehicle 900 may use an optical sensor as sensor 904 to determine a state of plants in an environment proximate vehicle 900. Actuator 906 may be a nozzle configured to spray chemicals. Depending on an identified species and/or an identified state of the plants, actuator control command 902 may be determined to cause actuator 906 to spray the plants with a suitable quantity of suitable chemicals.

Vehicle 900 may be an at least partially autonomous robot in the form of a domestic appliance. Non-limiting examples of domestic appliances include a washing machine, a stove, an oven, a microwave, or a dishwasher. In such a vehicle 900, sensor 904 may be an optical or acoustic sensor configured to detect a state of an object which is to undergo processing by the household appliance. For example, in the case of the domestic appliance being a washing machine, sensor 904 may detect a state of the laundry inside the washing machine. Actuator control command may be determined based on the detected state of the laundry.

In this embodiment, the control system 902 would receive image information from the sensor 904. Using the image input and a DEQ trained for image classification or semantic segmentation tasks stored in the system, the control system 902 may classify each pixel of the image received from sensor 904. Based on this classification, signals may be sent to actuator 906, for example, to brake or turn to avoid collisions with pedestrians or trees, to steer to remain between detected lane markings, or any of the actions performed by the actuator 906 as described above. Signals may also be sent to sensor 904 based on this classification, for example, to focus or move a camera lens.

In another example, FIG. 10 illustrates an example of a control system 1002 configured to control a monitoring system 1000. Monitoring system 1000 may be configured to physically control access through a door. Sensor 1004 may be configured to detect a scene that is relevant in deciding whether access is granted. Sensor 1004 may be an optical or acoustic sensor or sensor array configured to generate and transmit image and/or video data. Such data may be used by control system 1002 to detect a person's face.

Monitoring system 1000 may also be a surveillance system. In such an embodiment, sensor 1004 may be a wave energy sensor such as an optical sensor, infrared sensor, acoustic sensor configured to detect a scene that is under surveillance and control system 1002 is configured to control display 1008. Control system 1002 is configured to determine a classification of a scene, e.g. whether the scene detected by sensor 1004 is suspicious. A perturbation object may be utilized for detecting certain types of objects to allow the system to identify such objects in non-optimal conditions (e.g., night, fog, rainy, interfering background noise etc.). Control system 1002 is configured to transmit an actuator control command to display 1008 in response to the classification. Display 1008 may be configured to adjust the displayed content in response to the actuator control command. For instance, display 1008 may highlight an object that is deemed suspicious by controller 1002.

In this embodiment, the control system 1002 would receive image information from sensor 1004. Using the image input and a DEQ trained for image classification or semantic segmentation tasks stored in the system, the control system 1002 may classify each pixel of the image received from sensor 1004 in order to, for example, detect the presence of suspicious or undesirable objects in the scene, to detect types of lighting or viewing conditions, or to detect movement. Based on this classification, signals may be sent to actuator 1006, for example, to lock or unlock doors or other entryways, to activate an alarm or other signal, or any of the actions performed by the actuator 1006 as described in the above sections. Signals may also be sent to sensor 1004 based on this classification, for example, to focus or move a camera lens.

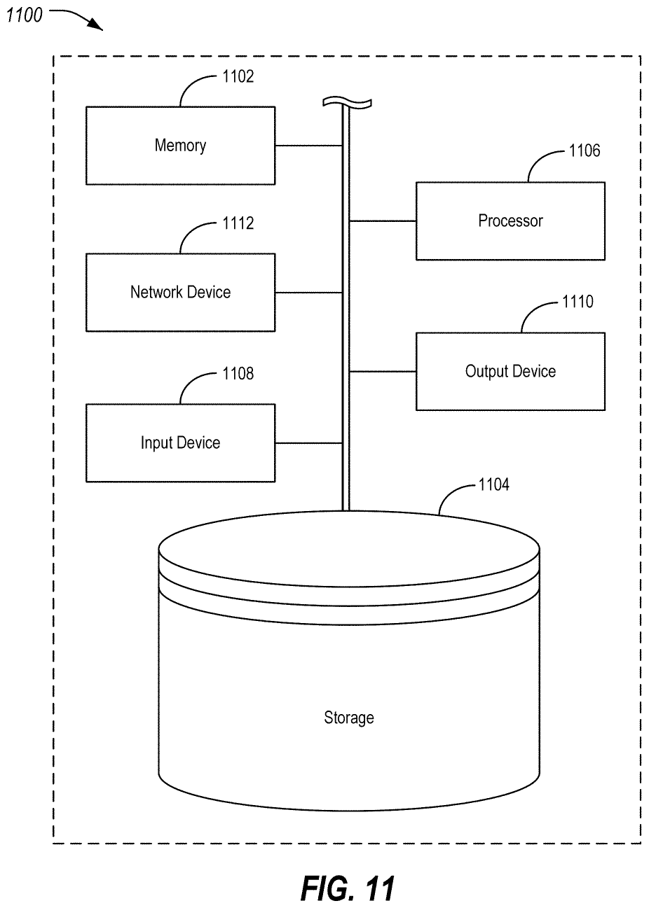

The algorithms and/or methodologies of one or more embodiments discussed herein (such as the DEQ training discussed in FIGS. 1-7 and/or the applications discussed in FIGS. 8-10) are implemented using a computing device, such as the computing platform 1100 illustrated in FIG. 11. The computing platform 1100 may include memory 1102, a non-volatile storage 1104, a processor 1106, an input device 1108, an output device 1110, and a network device 1112.

The memory 1102 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. The non-volatile storage 1104 may include one or more persistent data storage devices such as a hard drive, optical drive, tape drive, non-volatile solid-state device, cloud storage or any other device capable of persistently storing information.

The processor 1106 may include one or more devices selected from high-performance computing (HPC) systems including high-performance cores, microprocessors, micro-controllers, digital signal processors, microcomputers, central processing units (CPU), graphical processing units (GPU), tensor processing units (TPU), field programmable gate arrays, programmable logic devices, state machines, logic circuits, analog circuits, digital circuits, or any other devices that manipulate signals (analog or digital) based on computer-executable instructions residing in memory 1102.

The processor 1106 may be configured to read into memory 1102 and execute computer-executable instructions residing in the non-volatile storage 1104. Upon execution by the processor 1106, the computer-executable instructions may cause the computing platform 1100 to implement one or more of the algorithms and/or methodologies disclosed herein.

The computing platform 1100 may further include one or more input devices 1108, such as buttons and/or touch-sensitive displays screens, and output devices 810 such as lights, speakers, and/or display screens. The computing platform 1100 may also include one or more network devices 812, such as modems or other wired or wireless transceivers that may be used to allow the computing platform 1100 to communicate with other computing platforms 1100 over a communications network.

Computer-readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for regularized training of a Deep Equilibrium Model (DEQ), comprising:
computing a regularization term using a predefined quantity of random samples and the Jacobian matrix of the DEQ, the regularization term penalizing the spectral radius of the Jacobian matrix;
including the regularization term in an original loss function of the DEQ to form a regularized loss function;
computing a gradient of the regularized loss function with respect to model parameters of the DEQ; and
using the gradient to update the model parameters.

2. The method of claim 1, wherein the predefined quantity is defined for approximating a Frobenius norm of the DEQ, and further comprising regularizing the Jacobian matrix using the Frobenius norm of the Jacobian matrix.

3. The method of claim 2, further comprising using a Hutchinson estimator to estimate the Frobenius norm.

4. The method of claim 3, further comprising approximating the Hutchinson estimator using Monte-Carlo estimation.

5. The method of claim 2, further comprising applying an upper bound on the spectral radius of the Jacobian matrix to estimate the Frobenius norm.

6. The method of claim 1, wherein the regularization term is weighted in the regularized loss function according to a predefined coefficient, the coefficient controlling a relative importance of the regularization term in the regularized loss function.

7. The method of claim 1, further comprising iteratively performing the operations of claim 1 for a plurality of training cycles.

8. The method of claim 1, further comprising utilizing the DEQ for sequence prediction, language modeling, computer vision tasks, image classification, and/or semantic segmentation.

9. A system for regularized training of a Deep Equilibrium Model (DEQ), comprising:
one or more computing devices programmed to
compute a regularization term using a predefined quantity of random samples and the Jacobian matrix of the DEQ, the regularization term penalizing the spectral radius of the Jacobian matrix,
include the regularization term in an original loss function of the DEQ to form a regularized loss function,
compute a gradient of the regularized loss function with respect to model parameters of the DEQ, and
use the gradient to update the model parameters.

10. The system of claim 9, wherein the predefined quantity is defined for approximating a Frobenius norm of the DEQ, and the one or more computing devices are further programmed to regularize the Jacobian matrix using the Frobenius norm of the Jacobian matrix.

11. The system of claim 10, wherein the one or more computing devices are further programmed to use a Hutchinson estimator to estimate the Frobenius norm.

12. The system of claim 11, wherein the one or more computing devices are further programmed to approximate the Hutchinson estimator using Monte-Carlo estimation.

13. The system of claim 10, wherein the one or more computing devices are further programmed to apply an upper bound on the spectral radius of the Jacobian matrix to estimate the Frobenius norm.

14. The system of claim 9, wherein the regularization term is weighted in the regularized loss function according to a predefined coefficient, the coefficient being configured to control a relative importance of the regularization term in the regularized loss function.

15. The system of claim 9, wherein the one or more computing devices are further programmed to iteratively perform the operations of claim 9 for a plurality of training cycles.

16. The system of claim 9, wherein the one or more computing devices are further programmed to utilize the DEQ for sequence prediction, language modeling, computer vision tasks, image classification, and/or semantic segmentation.

17. A non-transitory computer-readable medium comprising instructions for regularized training of a Deep Equilibrium Model (DEQ) that, when executed by one or more computing devices, cause the one or more computing device to perform operations including to:
compute a regularization term using a predefined quantity of random samples and the Jacobian matrix of the DEQ, the regularization term penalizing the spectral radius of the Jacobian matrix, the predefined quantity being defined for approximating a Frobenius norm of the Jacobian matrix;
include the regularization term in an original loss function of the DEQ to form a regularized loss function to regularize the Jacobian matrix using the Frobenius norm, the regularization term being weighted in the regularized loss function according to a predefined coefficient, the coefficient being configured to control a relative importance of the regularization term in the regularized loss function;
compute a gradient of the regularized loss function with respect to model parameters of the DEQ; and
use the gradient to update the model parameters.

18. The medium of claim 17, further comprising instructions that when executed by the one or more computing devices, cause the one or more computing device to perform operations including to use a Hutchinson estimator to estimate the Frobenius norm using Monte-Carlo estimation.

19. The medium of claim 17, further comprising instructions that when executed by the one or more computing devices, cause the one or more computing device to perform operations including to apply an upper bound on the spectral radius of the Jacobian matrix to estimate the Frobenius norm.

20. The medium of claim 17, further comprising instructions that when executed by the one or more computing devices, cause the one or more computing device to perform operations including to utilize the DEQ for sequence prediction and/or language modeling.
